(19) United States
(12) Patent Application Publication
(10) Pub. No.: US 2006/0036771 A1
(43) Pub. Date: Feb. 16, 2006

(54) Information processing capability transaction apparatus and method thereof

(76) Inventors: Katsuya Yokomura, Yokohama (JP); Mitsuru Hirasawa, Kawasaki (JP); Tatsuya Saito, Kunitachi (JP); Masahiro Nagakura, Yamato (JP); Aya Moriyoshi, Tokyo (JP); Hirobumi Hashimoto, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/157,852

(22) Filed: Jun. 22, 2005

(30) Foreign Application Priority Data
Jun. 24, 2004 (JP) 2004-185793

(51) Int. Cl. G06F 15/16

(52) U.S. Cl. 709/249

(57) ABSTRACT

A request for operating a calculation module which calculates processing environments of data processing corresponding to bid plan information is transmitted to an information processing capability providing apparatus which indicates possible conditions on which the data processing can be made and which match to desired conditions for the data processing of an information processing capability delivery and receipt apparatus and contained in the bid plan information and processing environment information calculated and received from the information processing capability providing apparatus is transmitted to the information processing capability delivery and receipt apparatus. The processing environments of the data processing such as stability, accuracy and communication network state are important decision material in decision of a provider which is requested to make the data processing.

### BACKGROUND OF THE INVENTION

The present invention relates to execution of data processing in execution of information processing or/and program and more particularly to an information processing capability transaction apparatus for brokering transactions between an information processing capability delivery and receipt apparatus which transmits an execution request of data processing and information processing capability providing apparatuses which execute the data processing and a transaction method thereof.

A transaction brokering system for brokering transactions between service resource providers of information processing and service users is disclosed in US 2002/0116234 A1, for example. In this patent publication, the transaction brokering system holds performance of resources of the service resource providers as credit management data and predictively calculates combinations of resources offered which satisfy requirements on the basis of the performance request specifications presented by a service user and the credit management data, so that a utilization reservation ticket of the resources is issued to the user and a utilization reservation contract of the resources is issued to the service resource provider.

Processing environments, such as stability and accuracy of data processing and states of a communication network, which are dynamic information in execution capability of data processing and influence processing capability of data processing when practical processing is executed are important decision material for decision of the provider to which data processing is requested. In the US 2002/0116234 A1, in order to decide a provider of the service resources, the credit management data is updated on the basis of past performance information upon execution of service and the next provider of the service resource is decided.

However, the past performance information cannot deal with the case where execution of a new program or processing of information is desired and the case where a plurality of data processing is executed simultaneously by an information processing capability. providing apparatus, for example.

### SUMMARY OF THE INVENTION

It is an object of the present invention to provide processing environment information indicative of processing environments of data processing of an information processing capability providing apparatus which executes the data processing to an information processing capability delivery and receipt apparatus which requests the data processing.

In order to achieve the above object, according to an aspect of the present invention, a request for operating a calculation module which calculates processing environments of data processing corresponding to bid plan information 4 is transmitted to an information processing capability providing apparatus which indicates possible conditions on which the data processing can be made and which match to desired conditions for the data processing of an information processing capability delivery and receipt apparatus and contained in the bid plan information 4 and processing environment information calculated and received from the information processing capability providing apparatus is transmitted to the information processing capability delivery and receipt apparatus.

According to another aspect of the present invention, the information processing capability transaction apparatus connected through a transmission path to an information processing capability delivery and receipt apparatus which transmits request information for requesting data processing in execution of information processing or/and program and a plurality of information processing capability providing apparatuses which execute the data processing comprises reception means for receiving a plurality of answerable bid plan information containing possible conditions on which the data processing can be made by the information processing capability providing apparatuses and identifiers for identifying the information processing capability providing apparatuses from the plurality of information processing capability providing apparatuses and bid plan information containing desired conditions of the data processing from the information processing capability delivery and receipt apparatus, memory means for storing the plurality of answerable bid plan information received in a memory unit, retrieval means for retrieving the answerable bid plan information containing the possible conditions corresponding to said received desired conditions from said memory unit and transmission means for transmitting a request for operating a calculation module which calculates processing environment information indicative of processing environments of the data processing corresponding to the bid plan information to the information processing capability providing apparatus identified by the identifier contained in the retrieved answerable bid plan information and the reception means receives the processing environment information calculated, the transmission means transmitting the processing environment information to the information processing capability delivery and receipt apparatus.

### BRIEF DESCRIPTION OF THE DRAWINGS

FIG. 1 is a flowchart 1 showing processing operation of an information processing capability transaction apparatus according to an embodiment of the present invention;

FIG. 2 is a block diagram schematically illustrating the information processing capability transaction apparatus of the embodiment;

FIG. 3 is a schematic diagram illustrating a processing environment information calculation module;

FIG. 4 shows structure of records of bid plan information 4 and examples of data thereof;

FIG. 5 shows structure of records of answerable bid plan information 5 and examples of data thereof;

FIG. 6 shows structure of records of processing environment information calculation module information and examples of data thereof;

FIG. 7 shows structure of records of processing environment information calculation result information and examples of data thereof;

FIG. 8 shows structure of records of bid standard information and examples of data thereof;

FIG. 9 is a flowchart 2 showing processing operation in steps 11 to 13 of FIG. 1;

FIG. 10 is a flowchart 3 showing processing operation in step 94 of FIG. 9;

FIG. 11 is a flowchart 4 showing processing operation in step 96 of FIG. 9;

FIG. 12 is a flowchart 5 showing processing operation in step 113 of FIG. 11;

FIG. 13 is a flowchart 6 showing processing operation in step 114 of FIG. 11;

FIG. 14 is a flowchart 7 showing processing operation in step 14 of FIG. 1;

FIG. 15 shows an example of a display picture of a product list;

FIG. 16 is a flowchart showing processing operation of an information processing capability transaction apparatus according to another embodiment 2 of the present invention; and

FIG. 17 is a block diagram schematically illustrating the information processing capability transaction apparatus according to the embodiment 2 of the present invention.

### DETAILED DESCRIPTION OF THE EMBODIMENTS

Embodiments 1 and 2 are now described with reference to the accompanying drawings.

### Embodiment 1

In the embodiment 1, an information processing capability transaction apparatus provides processing environment information indicative of processing environments of data processing of an information processing capability providing apparatus which executes data processing to an information processing capability delivery and receipt apparatus which requests data processing in execution of information processing or/and program.

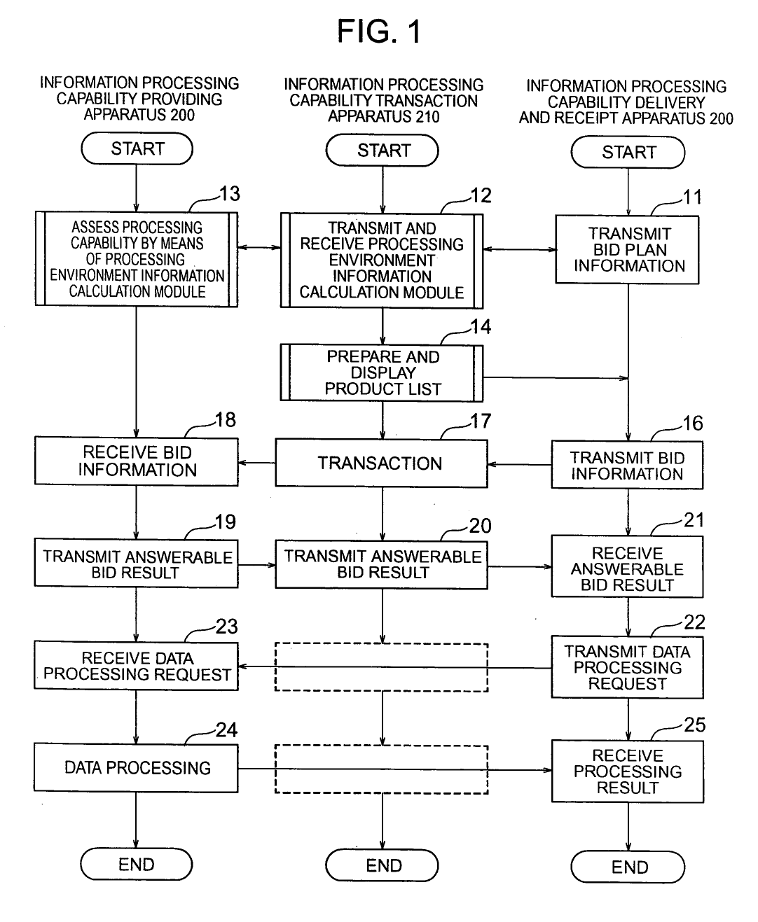

FIG. 1 is a flowchart showing processing operation of the information processing capability providing apparatus, the information providing capability transaction apparatus and the information processing capability delivery and receipt apparatus. Detailed description thereof will be made later.

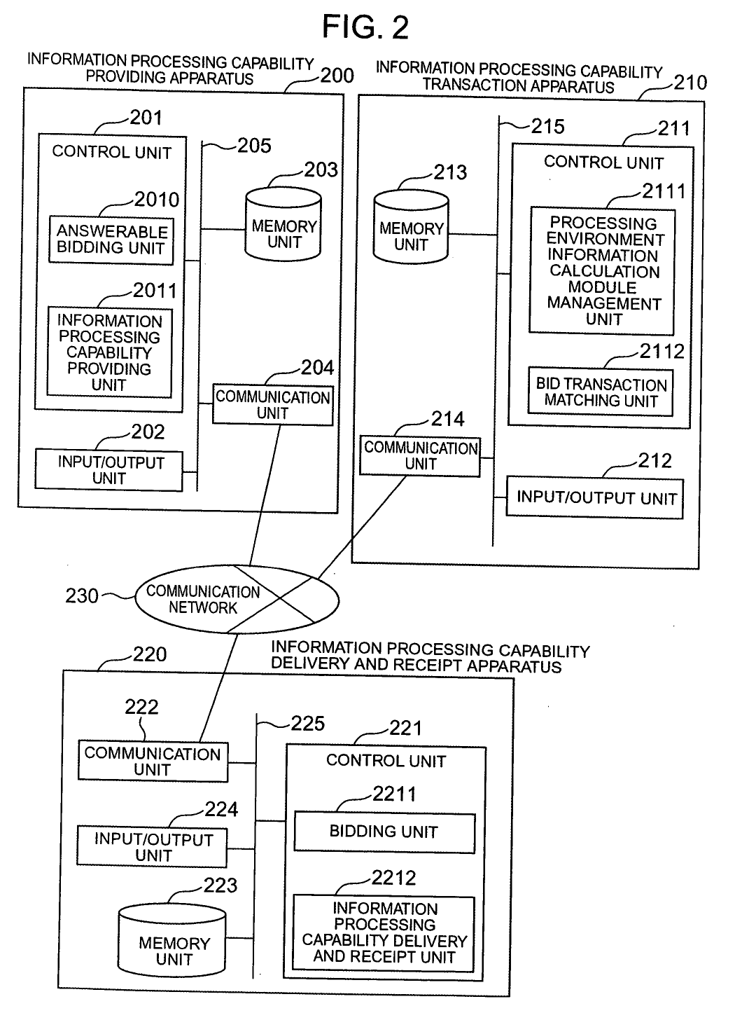

FIG. 2 is a schematic diagram illustrating the information processing capability providing apparatus, the information providing capability transaction apparatus and the information processing capability delivery and receipt apparatus of the embodiment. In FIG. 2, numeral 200 denotes the information processing capability providing apparatus, 201 a control unit, 202 an input/output unit, 203 a memory unit, 204 a communication unit, 205 a data bus, 210 the information processing capability transaction apparatus, 211 a control unit, 212 an input/output unit, 213 a memory unit, 214 a communication unit, 220 the information processing capability delivery and receipt apparatus, 221 a control unit, 222 a communication unit, 223 a memory unit, 224 an input/output unit and 230 a communication network.

As shown in FIG. 2, the information processing capability transaction apparatus of the embodiment includes the information processing capability providing apparatus 200 having 5 units, the information processing capability transaction apparatus 210 having 5 units and the information processing capability delivery and receipt apparatus 220 having 5 units. These functions are operated by means of hardware constituting the respective apparatuses and programs controlling the hardware.

The first unit of the information processing capability providing apparatus 200 includes the control unit 201 which controls execution of programs for an answerable bidding unit 2010 and an information processing capability providing unit 2011 which are operated in the information processing capability providing apparatus 200.

The second unit of the information processing capability providing apparatus 200 includes the input/output unit 202 constituting a user interface between a manager or a user who manages the information processing capability providing apparatus 200 and it and including an input device such as a mouse and a keyboard by which the manager and the user can make inputting of information, an output device such as a display which displays pictures to the user and a loudspeaker which produces voice and sound and programs which control execution of the input device, the output device and the above-mentioned other devices.

The third unit of the information processing capability providing apparatus 200 includes the memory unit 203 which stores information treated in the information processing capability providing apparatus 200.

The fourth unit of the information processing capability providing apparatus 200 includes the communication unit 204 having the function of transmitting and receiving information in order that the information processing capability providing apparatus 200 communicates with the information processing capability transaction apparatus 210 and the information processing capability delivery and receipt apparatus 220 through the communication network 230.

The fifth unit of the information processing capability providing apparatus 200 includes the data bus 205 which makes it possible to deliver and receive data among the control unit 201, the input/output unit 202, the memory unit 203 and the communication unit 204 in order to operate the control unit 201, the input/output unit 202, the memory unit 203 and the communication unit 204 in cooperation with one another.

The first unit of the information processing capability transaction apparatus 210 includes the control unit 211 which controls execution of programs for a processing environment information calculation module management unit 2111 and a bid transaction matching unit 2112 which are operated in the information processing capability transaction apparatus 210.

The second unit of the information processing capability transaction apparatus 210 includes the input/output unit 212 constituting a user interface between a manager or a user who manages the information processing capability transaction apparatus 210 and it and including an input device such as a mouse and a keyboard by which the manager and the user can make inputting of information, an output device such as a display which displays pictures to the user and a loudspeaker which produces voice and sound and programs which control execution of the input device, the output device and the above-mentioned other devices.

The third unit of the information processing capability transaction apparatus 210 includes the memory unit 213 which stores information treated in the information processing capability transaction apparatus 210.

The fourth unit of the information processing capability transaction apparatus 210 includes the communication unit 214 having the function of transmitting and receiving information in order that the information processing capability transaction apparatus.210 communicates with the information processing capability providing apparatus 200 and the information processing capability delivery and receipt apparatus 220 through the communication network 230.

The fifth unit of the information processing capability transaction apparatus 210 includes a data bus 215 which makes it possible to deliver and receive data among the control unit 211, the input/output unit 212, the memory unit 213 and the communication unit 214 in order to operate the control unit 211, the input/output unit 212, the memory unit 213 and the communication unit 214 in cooperation with one another.

The first unit of the information processing capability delivery and receipt apparatus 220 includes the control unit 221 which controls execution of programs for a bidding unit 2211 and an information processing capability delivery and receipt unit 2212 which are operated in the information processing capability delivery and receipt apparatus 220.

The second unit of the information processing capability delivery and receipt apparatus 220 includes the input/output unit 224 constituting a user interface between a manager or a user who manages the information processing capability delivery and receipt apparatus 220 and it and including an input device such as a mouse and a keyboard by which the user can make inputting of information, an output device such as a display which displays pictures to the user and a loudspeaker which produces voice and sound and programs which control execution of the input device, the output device and the above-mentioned other devices.

The third unit of the information processing capability delivery and receipt apparatus 220 includes the memory unit 223 which stores information treated in the information processing capability delivery and receipt apparatus 220.

The fourth unit of the information processing capability delivery and receipt apparatus 220 includes the communication unit 222 having the function of transmitting and receiving information in order that the information processing capability delivery and receipt apparatus 220 communicates with the information processing capability providing apparatus 200 and the information processing capability transaction apparatus 210 through the communication network 230.

The fifth unit of the information processing capability delivery and receipt apparatus 220 includes a data bus 225 which makes it possible to deliver and receive data among the control unit 221, the input/output unit 224, the memory unit 223 and the communication unit 222 in order to operate the control unit 221, the input/output unit 224, the memory unit 223 and the communication unit 222 in cooperation with one another.

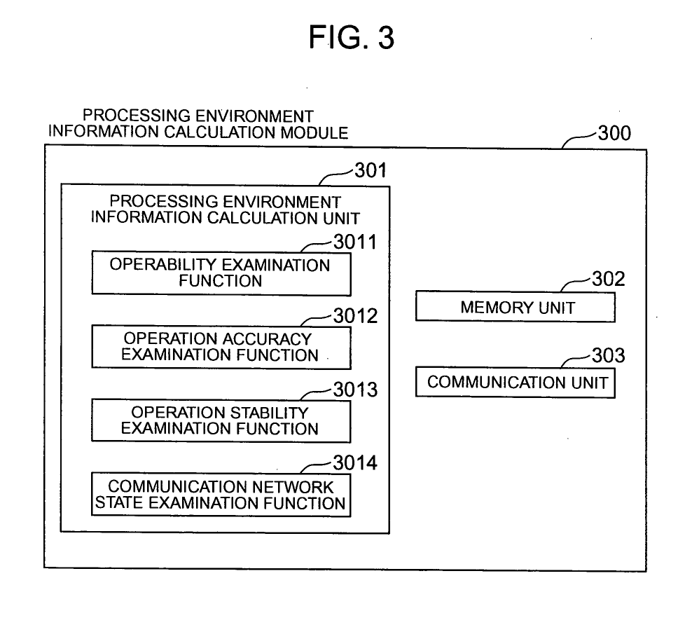

FIG. 3 is a diagram schematically illustrating a processing environment information calculation module. In FIG. 3, numeral 300 denotes the processing environment information calculation module, 301 a processing environment information calculation unit, 302 a memory unit and 303 a communication unit.

As shown in FIG. 3, in the information processing capability transaction apparatus of the embodiment, the processing environment information calculation module 300 includes three program functions.

The first unit of the processing environment information calculation module 300 is the processing environment information calculation unit 301 having four functions for calculating processing environment information. The first function of the processing environment information calculation unit 301 is an operability examination function 3011 which judges whether a test program is operated in the information processing capability providing apparatus 200 or not. The second function of the processing environment information calculation unit 301 is an operation accuracy examination function 3012 which judges whether the result of the test program in the information processing capability providing apparatus 200 is correct or not. The third function of the processing environment information calculation unit 301 is an operation stability examination function 3013 which judges the test program is operated stably in the information processing capability providing apparatus 200 or not. The fourth function of the processing environment information calculation unit 301 is a communication network state examination function 3014 which measures the state of the network connected to the information processing capability providing apparatus 200 such as, for example, communication speed and occurrence frequency of communication errors to judge the communication quality thereof.

The second unit of the processing environment information calculation module 300 is the memory unit 302 which stores set information of operation contents of the processing environment information calculation unit 301 and the result assessed by the processing environment information calculation unit 301.

The third unit of the processing environment information calculation module 300 is the communication unit 303 having the function that the processing environment information calculation module communicates with the apparatuses.

The processing environment information calculation modules 300 are provided so that the processing environment information can be calculated for each of services, operation OS (operation system) and operation middleware provided by the respective information processing capability providing apparatuses 200. In order to calculate the processing environment information for a plurality of different services, operation OS and operation middleware provided by the information processing capability providing apparatus 200, the processing environment information calculation module 300 includes the processing environment information calculation unit 301 suitable for each of the plurality of different services, operation OS and operation middleware.

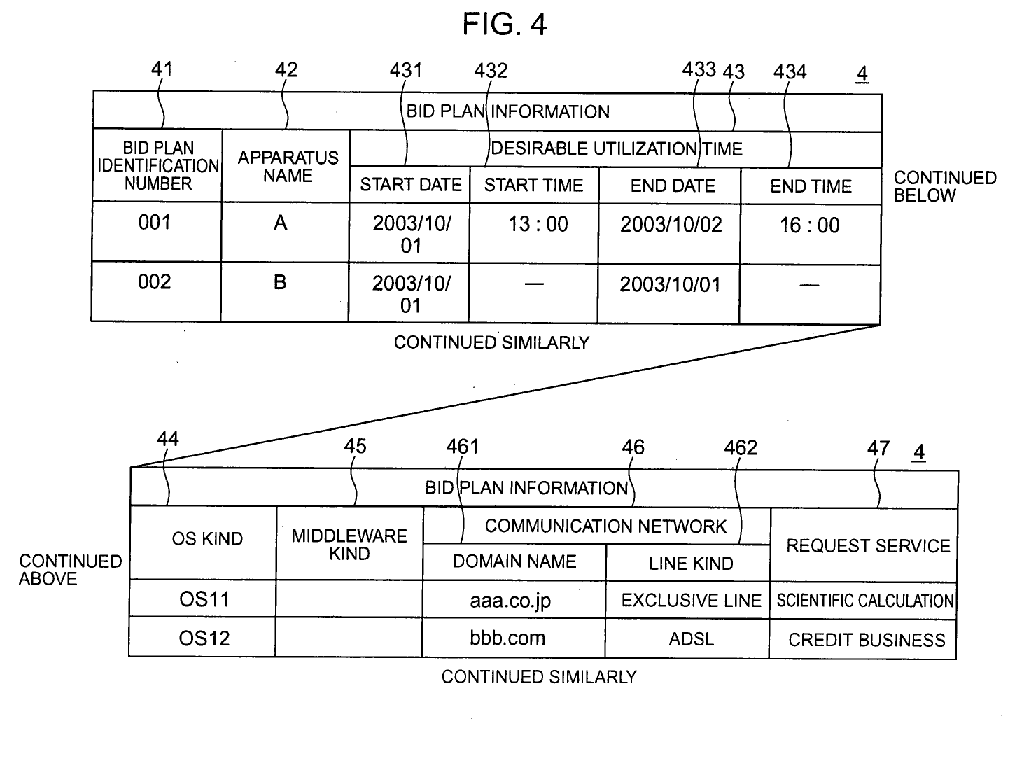

FIG. 4 is a diagram showing structure of records of bid plan information 4 and examples of data corresponding to the records in the embodiment.

The bid plan information 4 shown in FIG. 4 is stored in the memory units 213 and 223. In FIG. 4, numeral 4 denotes bid plan information, 41 bid plan identification number record in which information for identifying individual bid plan information 4 is entered, 42 apparatus name record in which name information of the information processing capability delivery and receipt apparatus which is planning to make a bid is entered, 43 desired utilization time record in which information of desired time, that is, date and time that data processing is executed by the information processing capability delivery and receipt apparatus 220 is entered, 44 OS kind record in which kind information of an operating system (OS) desired to be provided as the information processing capability of an apparatus to which the information processing capability delivery and receipt apparatus 220 is planning to make a bid is entered, 45 middleware kind record in which kind information of middleware desired to be provided as the information processing capability of the apparatus to which the information processing capability delivery and receipt apparatus 220 is planning to make a bid is entered, 46 communication network record in which information of a communication network to which the apparatus to which the information processing capability delivery and receipt apparatus 220 is planning to make a bid is connected is entered and 47 request service record in which kind information of service desired to be provided by the information processing capability providing apparatus to which a bid is planned to be made is entered. Information entered in the records 43, 44, 45, 46 and 47 is desired conditions for data processing desired for the information processing capability providing apparatus. Further, the apparatus name 42 is an identifier for identifying the information processing capability delivery and receipt apparatus 220.

Moreover, the desired utilization time record 43 includes sub-records containing start date record 431, start time record 432, end date record 433 and end time record 434. The communication network record 46 includes sub-records containing domain name record 461 and line kind record 462.

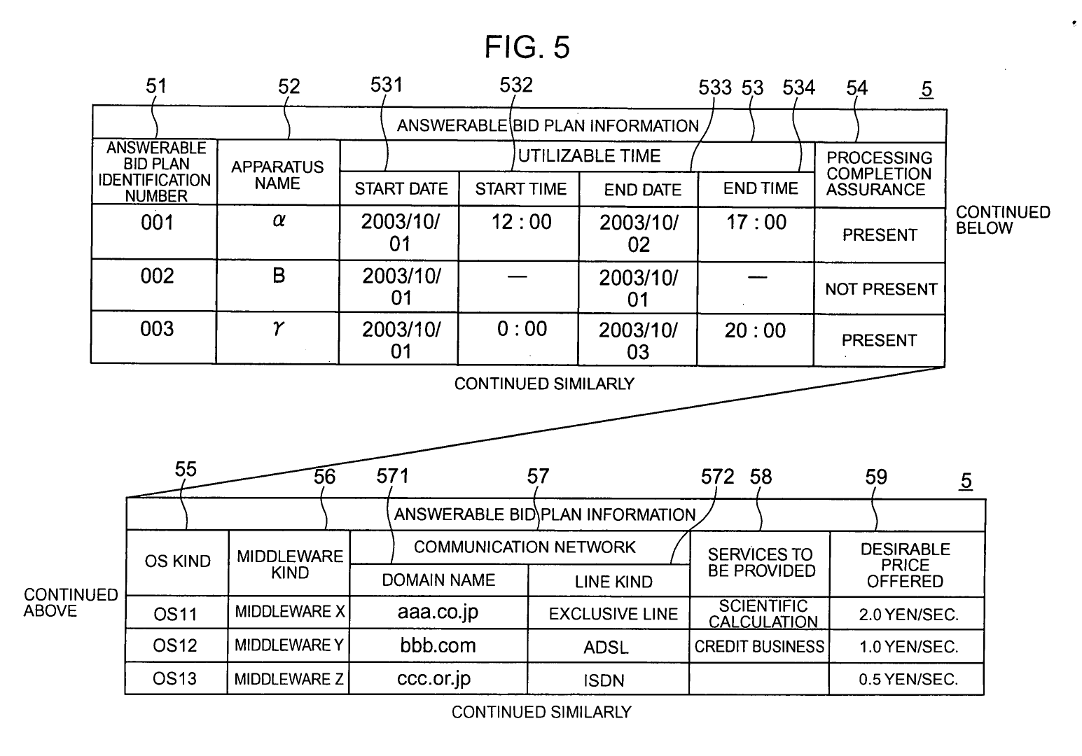

FIG. 5 is a diagram showing structure of records of answerable bid plan information 5 and examples of data corresponding to the records in the embodiment. The answerable bid plan information 5 shown in FIG. 5 is stored in the memory units 203 and 213.

In FIG. 5, numeral 5 denotes answerable bid plan information, 51 answerable bid plan identification number record in which information for identifying individual answerable bid plan information 5 is entered, 52 apparatus name record in which name information of the information processing capability providing apparatus 200 which is planning to make an answerable bid is entered, 53 utilizable time record in which information of term that data processing can be made by the information processing capability providing apparatus 200 is entered, 54 processing completion assurance record in which assurance that the information processing capability providing apparatus 200 continues to make data processing in response to a processing request received from the information processing capability delivery and receipt apparatus 220 until the data processing is completed even if the utilizable time is exceeded is present or not is entered, 55 OS kind record in which kind information of an operating system (OS) having operation environments of the operating system which the information processing capability providing apparatus 200 can provide as the information processing capability is entered, 56 middleware kind record in which kind information of middleware which the information processing capability providing apparatus 200 can provide as the information processing capability is entered, 57 communication network record in which information of a communication network to which the information processing capability providing apparatus 200 is connected is entered, 58 offered service record in which kind information of services which the information processing capability providing apparatus 200 can provide is entered and 59 desirable offered price record in which unit price (e.g. standard price decided on the basis of time and amount used) desired by the information processing capability providing apparatus 200 is entered. Information entered in the records 53, 54, 56, 57 and 58 is conditions on which the information processing capability providing apparatus can make data processing. Further, the apparatus name 52 is an identifier for identifying the information processing capability providing apparatus 200.

Moreover, the utilizable time record 53 includes sub-records containing start date record 531, start time record 532, end date record 533 and end time record 534. The communication network record 57 includes sub-records containing domain name record 571 and line kind record 572.

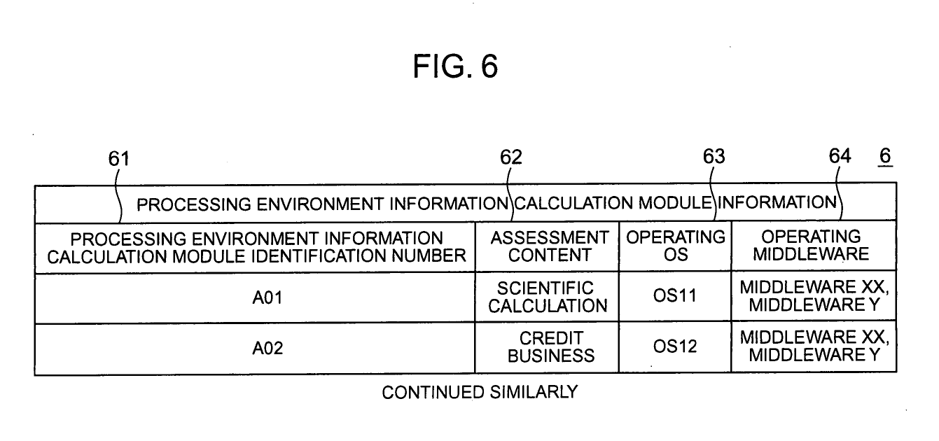

FIG. 6 is a diagram showing structure of records of processing environment information calculation module information indicative of the kind of the processing environment information calculation module and examples of data corresponding to the records.

The processing environment information calculation module information shown in FIG. 6 is stored in the memory unit 213. In FIG. 6, numeral 6 denotes processing environment information calculation module information, 61 processing environment information calculation module identification number record in which information for identifying the processing environment information calculation module is entered, 62 assessment content record in which information of assessment contents of the processing environment information calculation module is entered, 63 operation OS record in which information of the kind of an operating system (OS) in which the processing environment information calculation module is operated is entered and 64 operation middleware record in which information of the kind of middleware in which the processing environment information calculation module is operated is entered.

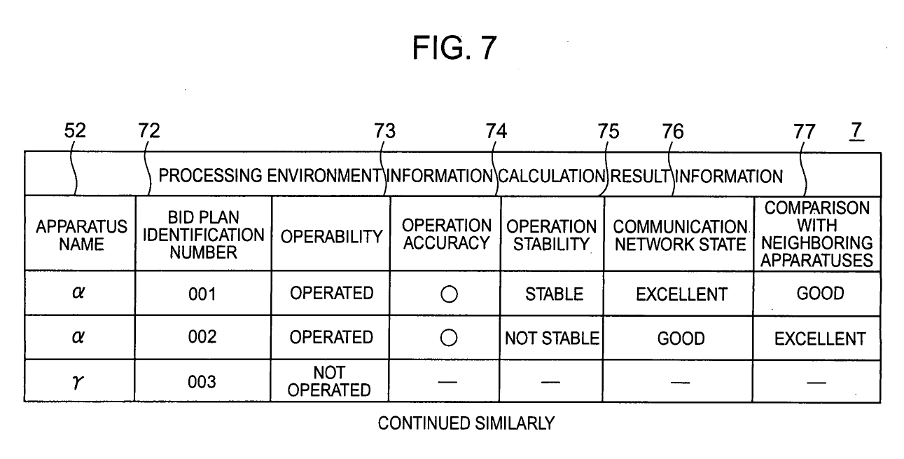

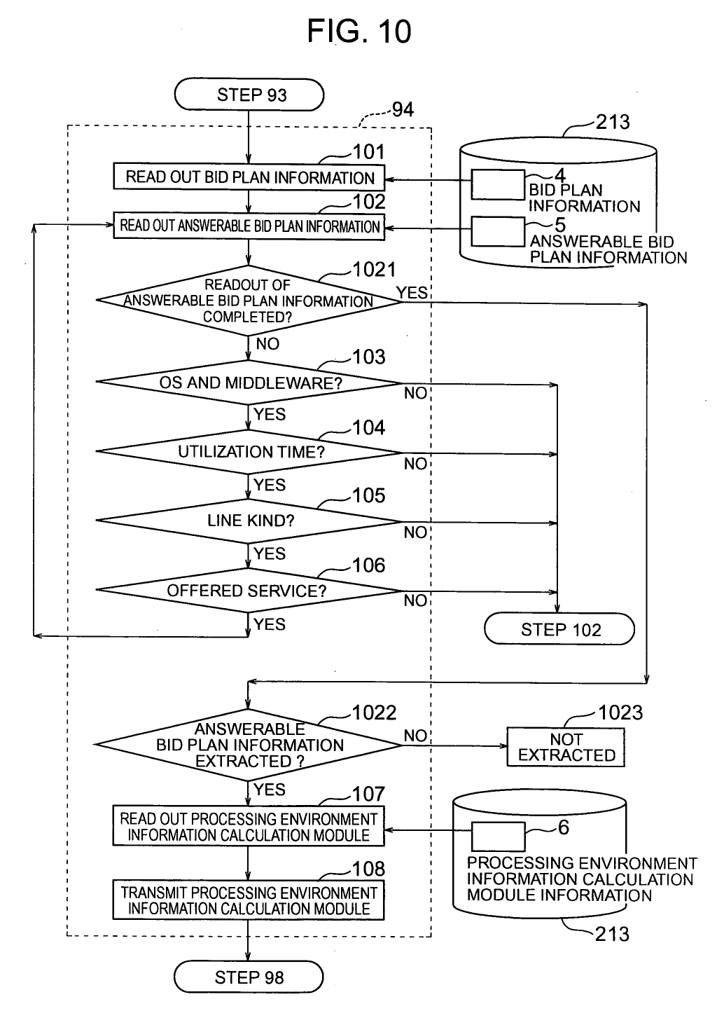

FIG. 7 shows processing environment information calculation result information indicative of processing environments for data processing of the information processing capability providing apparatus. The processing environment information calculation result information of FIG. 7 is a list of processing environment information calculation result information of the information processing capability providing apparatus 200 corresponding to the answerable bid plan information extracted in step 1022 of FIG. 10 described later. The processing environment information calculation result information is stored in the memory units 213 and 302. In FIG. 7, numeral 7 denotes processing environment information calculation result information, 52 apparatus name which is information for identifying the information processing capability providing apparatus, 72 bid plan identification number record in which information for identifying the bid plan information 4 is entered, 73 operability record in which assessment result of operability as to whether the information processing capability providing apparatus can be operated or not is entered, 74 operation accuracy record in which assessment result of operation accuracy of the information processing capability providing apparatus is entered, 75 operation stability record in which assessment result of operation stability of the information processing capability providing apparatus is entered, 76 communication network state record in which assessment result of the state of the communication network connected to the information processing capability providing apparatus is entered and 77 comparison-with- neighboring-apparatus record in which assessment result of the state of the communication network compared with neighboring apparatuses is entered.

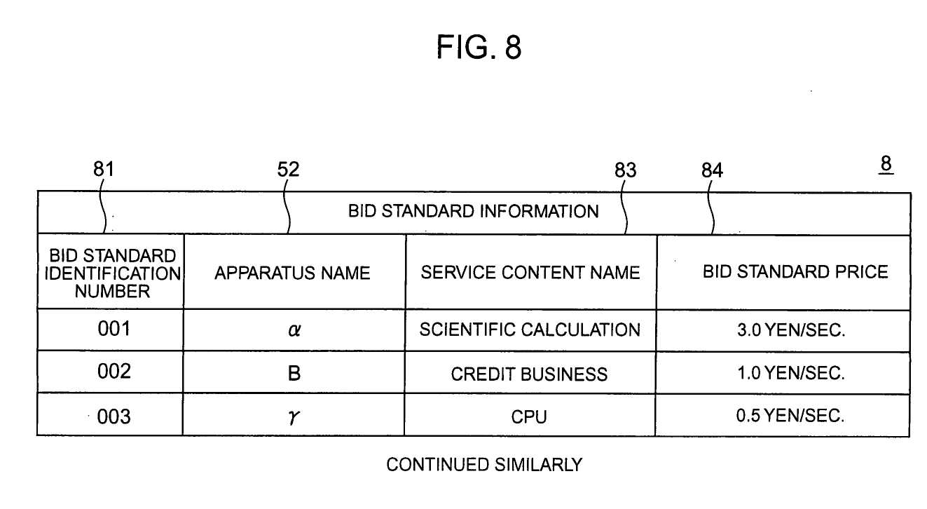

Bid standard information shown in FIG. 8 is stored in the memory unit 213. In FIG. 8, numeral 8 denotes bid standard information, 81 bid standard identification number record in which information for identifying individual bid standard information is entered, 52 apparatus name record in which apparatus name of the information processing capability providing apparatus is entered, 83 service content name record in which name information of service contents provided by the information processing capability providing apparatus 200 identified by the apparatus name 52 is entered and 84 bid standard price record in which bid standard price is entered.

Referring now to FIG. 1, the processing procedure of the embodiment is described.

As shown in FIG. 1, the information processing capability providing apparatus 200 executes processing in steps 13, 18, 19, 23 and 24. The information processing capability transaction apparatus 210 executes processing in steps 12, 14, 17 and 20. The information processing capability delivery and receipt apparatus 220 executes processing in steps 11, 16, 21, 22 and 25.

First, in step 11, the information processing capability delivery and receipt apparatus 220 transmits bid plan information 4 to the information processing capability transaction apparatus 210.

In step 12, the information processing capability transaction apparatus 210 transmits the processing environment information calculation module 300 to the information processing capability providing apparatus 200 on the basis of the bid plan information 4 transmitted in step 11 and receives processing environment information calculation result information 7 indicative of processing environments of data processing of the information processing capability providing apparatus 200 desired in the bid plan information 4 from the processing environment information calculation module 300.

In step 13, the information processing capability providing apparatus 200 receives the processing environment information calculation module 300 transmitted by the information processing capability transaction apparatus 210 in step 12 and calculates processing environment information of the information processing capability providing apparatus 200. The information processing capability providing apparatus 200 transmits from the processing environment information calculation module 300 the processing environment information calculation result information 7 to the information processing capability transaction apparatus 210.

In steps 12 and 13, the processing environment information calculation module may be previously stored in the information processing capability providing apparatus 200 and the information processing capability transaction apparatus 210 may transmit a request to operate the processing environment information calculation module to the information processing capability providing apparatus 200 instead of transmitting the processing environment information calculation module from the information processing capability transaction apparatus 210 to the information processing capability providing apparatus 200.

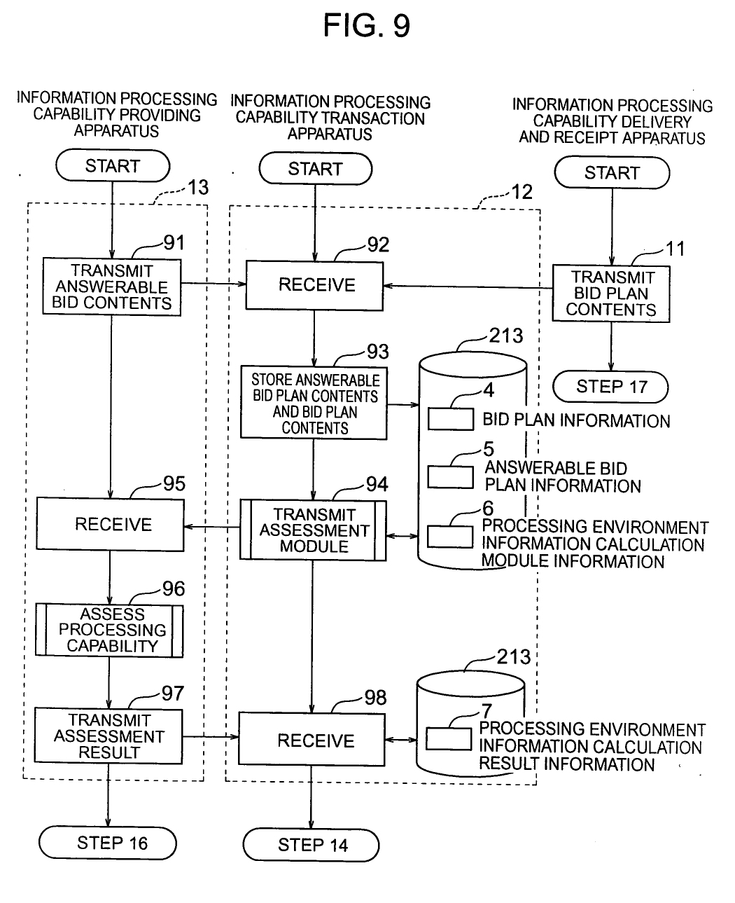

The processing in steps 11 to 13 will be described in detail with reference to FIG. 9.

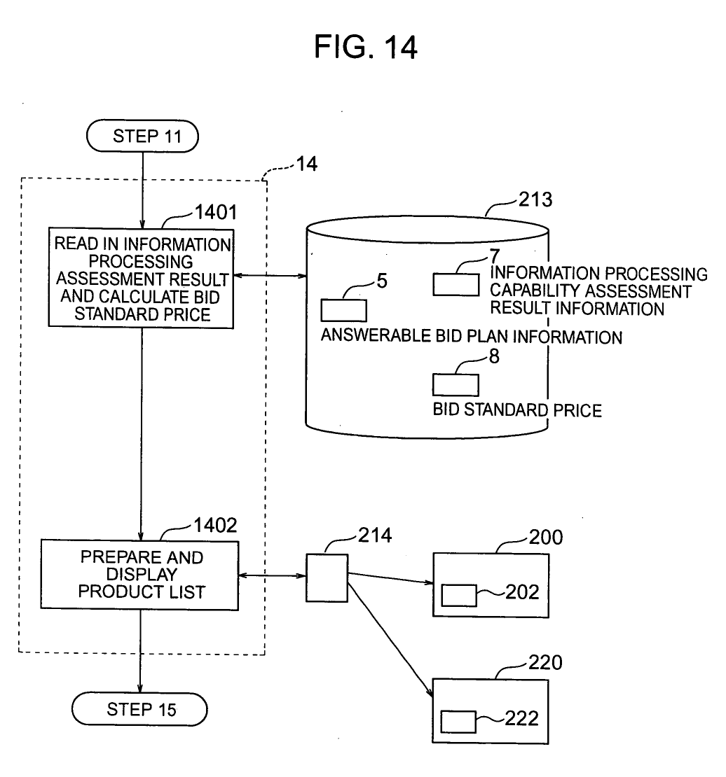

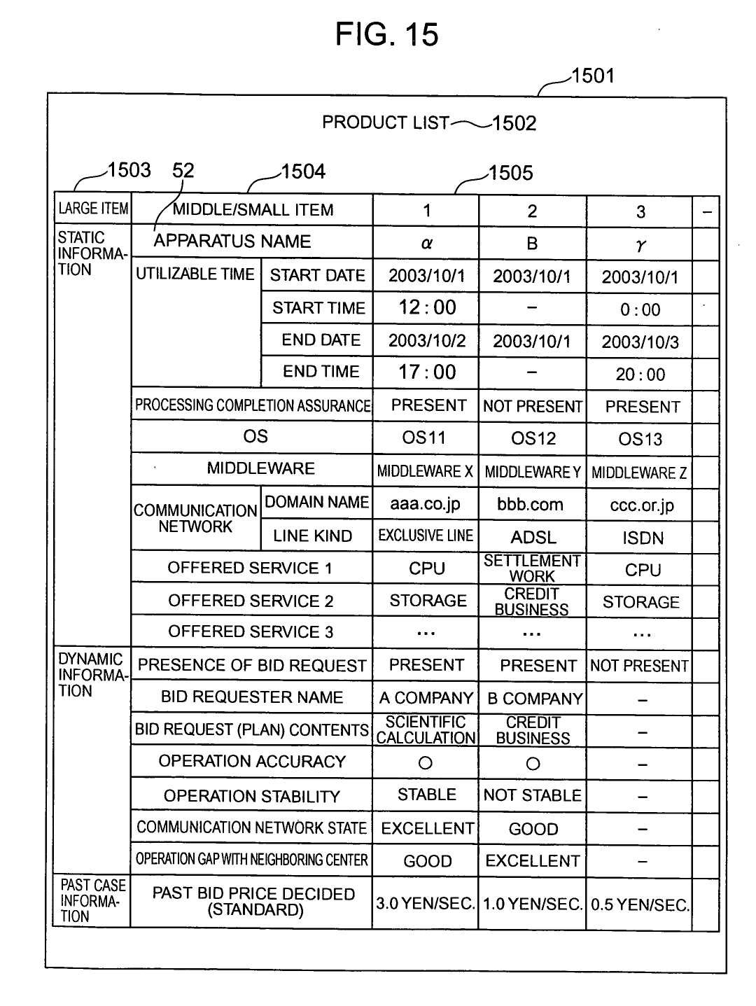

In step 14, the information processing capability transaction apparatus 210 sets an answerable bid standard price on the basis of the processing environment information calculated by the information processing providing apparatus 200 in step 13 and prepares a product list 1501 shown in FIG. 15 in which the name of the information processing capability providing apparatus, the processing environment information calculation result information 7 of the information processing capability providing apparatus and the answerable bid standard price are associated with one another to transmit it to the information processing capability providing apparatus 200 and the information processing capability delivery and receipt apparatus 220. Detailed processing in step 14 will be described with reference to FIG. 14.

In step 16, the information processing capability delivery and receipt apparatus 220 receives the product list 1501 and selects the information processing capability providing apparatus 200 to be required to execute data processing from information processing capability providing apparatuses 200 identified by the apparatus name 52. The information processing capability delivery and receipt apparatus 220 transmits bid information for requesting a bid and containing the identifier for identifying the information processing capability providing apparatus 200 to the information processing capability transaction apparatus 210.

In step 17, the information processing capability transaction apparatus 210 receives the bid information and decides an answerable bid price to transmit the bid information and the answerable bid price to the information processing capability providing apparatus 200 identified by the bid information.

In step 18, the information processing capability providing apparatus 200 receives the bid information.

In step 19, the information processing capability providing apparatus 200 prepares answerable bid result information indicating that answerable bid is made on the basis of the bid information received in step 18 and transmits the answerable bid result information to the information processing capability transaction apparatus 210.

In step 20, the information processing capability transaction apparatus 210 receives the answerable bid result information and transmits it to the information processing capability delivery and receipt apparatus 220.

In step 21, the information processing capability delivery and receipt apparatus 220 receives the answerable bid result information. In step 22, the information processing capability delivery and receipt apparatus 220 transmits request information for requesting data processing in execution of information processing or/and program to the information processing capability providing apparatus 200.

In step 23, the information processing capability providing apparatus 200 receives the request information. Further, in steps 21 and 23, information may be relayed through the information processing capability transaction apparatus 210.

In step 24, the information processing capability providing apparatus 200 makes data processing in execution of information processing or/and program and transmits its processing result to the information processing capability delivery and receipt apparatus 220. In step 25, the information processing capability delivery and receipt apparatus 220 receives the processing result. Further, in steps 24 and 25, the processing result may be relayed through the information processing capability transaction apparatus 210.

For simplification of the drawings, only one information processing capability providing apparatus is shown in FIGS. 1 and 2, although a plurality of information processing capability providing apparatuses 200 may be provided in the embodiment. Further, a plurality of information processing capability delivery and receipt apparatuses 220 may be also provided.

Referring now to the flowchart of FIG. 9, the processing procedure (steps 11 to 13) of transmitting the information processing calculation module 300 from the information processing capability transaction apparatus 210 to the information processing capability providing apparatus 200 and calculating the processing environment information of the information processing capability providing apparatus 200 is described in detail.

In step 11, the information processing capability delivery and receipt apparatus 220 transmits the bid plan information 4 to the information processing capability transaction apparatus 210. The apparatus name 42 of the information processing capability delivery and receipt apparatus, the desired utilization time 43 of the information processing capability providing apparatus, the kind 44 of OS environments, the kind 45 of middleware, the kind of the communication network 46 and the request service name 47 are transmitted as the bid plan information 4. In this connection, the information processing capability delivery and receipt apparatus 220 may previously store data received from the user who manages or utilizes the information processing capability delivery and receipt apparatus 220 by means of the input unit 224 in the memory unit 223 and may transmit it to the information processing capability transaction apparatus 210 in step 11.

In step 91, the information processing capability providing apparatus 200 transmits the answerable bid plan information 5 to the information processing capability transaction apparatus 210. The apparatus name 52 of the information processing capability providing apparatus, the utilizable time 53 that can be provided by the information processing capability providing apparatus, the processing completion assurance 54, the kind 55 of OS environments that can be provided by the information processing capability providing apparatus, the kind 56 of operation environments of middleware that can be provided by the information processing capability providing apparatus, the kind 57 of the communication network, the offered service 58 and the desirable price offered 59 are transmitted as the answerable bid plan information 5. In this connection, the information processing capability providing apparatus 200 may previously store data received from the user who manages or utilizes the information processing capability providing apparatus 200 by means of the input unit 202 in the memory unit 203 and may transmit it to the information processing capability transaction apparatus 210 in step 91. Further, the execution order of steps 11 and 91 does not matter. The apparatus name 52 is the identifier for identifying the information processing capability providing apparatus 200.

In step 92, the information processing capability transaction apparatus 210 receives the bid plan information 4 transmitted by the information processing delivery and receipt apparatus 220 in step 11 and the answerable bid plan information 5 transmitted by the information processing capability providing apparatus 200 in step 91.

In step 93, the information processing capability transaction apparatus 210 adds the bid plan identification number 41 to the bid plan information 4 received in step 92 to be stored in the memory unit 213. Further, the information processing capability transaction apparatus 210 adds the answerable bid plan identification number 51 to the answerable bid plan information 5 received in step 92 to be stored in the memory unit 213.

In step 94, the information processing capability transaction apparatus 210 extracts the information processing capability calculation module 300 to be transmitted, from the processing environment information calculation module information 6 previously stored in the memory unit 213 on the basis of the bid plan information 4 and the answerable bid plan information 5 stored in the memory unit 213 and decides the information processing capability providing apparatus 200 to which the information processing capability calculation module 300 is to be transmitted. The processing environment information calculation module 300 is transmitted to the decided information processing capability providing apparatus 200. The processing in step 94 will be described in detail with reference to FIG. 10.

In step 95, the information processing capability providing apparatus 200 receives the processing environment information calculation module 300 from the information processing capability transaction apparatus 210.

The information processing capability calculation module may be stored in the information processing capability providing apparatus 200 in steps 94 and 95, the information processing capability transaction apparatus 210 may transmit a request to operate the information processing capability calculation module to the information processing capability apparatus 200 instead of extracting the information processing capability calculation module 300 in step 94, and the information processing capability providing apparatus 200 may receive the request to operate the information processing capability calculation module in step 95.

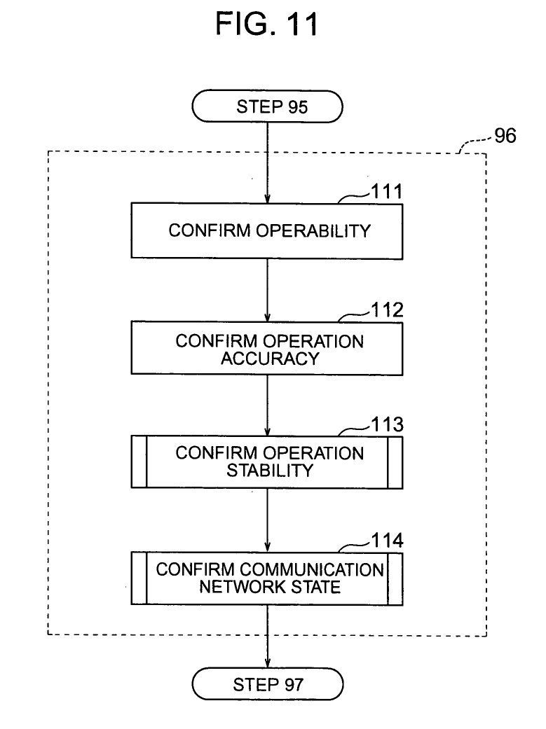

In step 96, the information processing capability providing apparatus 200 calculates the processing environment information indicative of the processing environment of data processing of the information processing capability providing apparatus 200 on the basis of the processing environment information calculation module 300 received in step 95. The calculated processing environment information is stored as the processing environment information calculation result information 7 in the memory unit 302. The processing in step 96 will be described in detail with reference to FIGS. 11 to 13.

In step 97, the information processing capability providing apparatus 200 transmits the processing environment information calculation result information 7 stored in the memory unit 302 in step 96 to the information processing capability transaction apparatus 210.

In step 98, the information processing capability transaction apparatus 210 receives the processing environment information calculation result information 7 from the information processing capability providing apparatus 200 and stores it in the memory unit 213.

Referring now to the flowchart of FIG. 10, the processing procedure (step 94 of FIG. 9) of transmitting the processing environment information calculation module 300 from the information processing capability transaction apparatus 210 is described in detail.

In step 101, the information processing capability transaction apparatus 210 reads out the bid plan information 4 stored in the memory unit 213.

In step 102, the information processing capability transaction apparatus 210 reads out one of the answerable bid plan information 5 stored in the memory unit 213.

In step 1021, when it is judged that the readout of the answerable bid plan information 5 in step 102 is completed, the process proceeds to step 1022. When it is not completed, the process proceeds to step 103.

In steps 103 to 106, the information processing capability transaction apparatus 210 retrieves possible conditions of the answerable bid plan information 5 corresponding to desired conditions of the bid plan information 4 to extract combinations of the bid plan information 4 and the answerable bid plan information 5. Accordingly, the processing in steps 102 to 106 is repeatedly executed plural times so that the answerable bid plan information 5 matching to the bid plan information 4 is extracted.

In step 103, the OS kind 44 and the middleware kind 45 of the bid plan information 4 read out in step 101 are compared with the OS kind 55 and the middleware kind 56 of the answerable bid plan information 5 read out in step 102. If both items are matched as a result of the comparison, the process proceeds to step 104 and if both items are not matched, the process is returned to step 102.

In step 104, the desired utilization time 43 of the bid plan information 4 read out in step 101 is compared with the utilizable time 53 of the answerable bid plan information 5. If the term of the desired utilization time 43 (start date 431, start time 432, end date 433 and end time 434) is within the term of the utilizable time 53 of the answerable bid plan information 5 (start date 531, start time 532, end date 533 and end time 534), the process proceeds to step 105. If the term of the desired utilization time 43 is outside of the term of the utilizable time 53, the process is returned to step 102.

In this connection, if the processing completion assurance 54 of the answerable bid plan information 5 is present even if the term of the desired utilization time 43 is outside of the term of the utilizable time 53 and even if the end data 433 and the end time 434 of the desired utilization time 43 are later than the end date 533 and the end time 534 of the utilizable time 53, the process proceeds to step 105.

In step 105, the line kind 462 of the bid plan information 4 read out in step 101 is compared with the line kind 572 of the answerable bid plan information 5 read out in step 102. If both items are matched as a result of the comparison, the process proceeds to step 106 and if both items are not matched, the process is returned to step 102.

In step 106, the request service 47 of the bid plan information 4 read out in step 101 is compared with the offered service 58 of the answerable bid plan information 5 read out in step 102. If both items are matched as a result of the comparison, the answerable bid plan information 5 read out in step 102 is temporarily stored in the memory unit 213 and the process proceeds to step 102. If both items are not matched, the process proceeds to step 102 without storing the answerable bid plan information 5.

In step 1022, it is judged whether the answerable bid plan information is extracted or not, that is, whether the answerable bid plan information is temporarily stored in the memory unit 213 or not as a result of the retrieval in steps 103 to 106. If it is not extracted, the process proceeds to step 1023 and if it is extracted, the process proceeds to step 107.

In step 1023, it is regarded that there is no answerable bid plan information 5 matching to the bid plan information 4 and information to the effect that there is no answerable bid plan information 5 matching to the bid plan information 4 is transmitted to the information processing capability delivery and receipt apparatus 220 identified by the apparatus name 42 of the bid plan information 4.

In step 107, the answerable bid plan information 5 extracted by the processing in steps 103 to 106 is used to retrieve the processing environment information calculation module 300 suitable for calculation of the processing environment information of the information processing capability providing apparatus 200 of the extracted answerable bid plan information 5 on the basis of judgment as to whether the offered service 58 and the assessment contents 62, the OS kind 55 and the operation OS 63 and the middleware kind 56 and the operation middleware 64 are matched to each other, respectively, so that the retrieved processing environment information calculation module 300 is read out. If a plurality of answerable bid plan information 5 is extracted, the processing environment information calculation modules 300 suitable for the respective answerable bid plan information are retrieved and read out.

In step 108, the processing environment information calculation module 300 read out in step 107 is transmitted to the information processing capability providing apparatus 200 corresponding to the extracted answerable bid plan information 5.

Referring now to the flowchart of FIG. 11, the processing procedure (step 96 of FIG. 9) of assessing the information processing capability of the information processing capability providing apparatus 200 is described in detail.

In step 111, the operability examination function 3011 in the processing environment information calculation unit 301 of the processing environment information calculation module 300 is executed in the information processing capability providing apparatus 200. The operability examination function 3011 judges whether the program for realizing the request service contents to be bid by the information processing capability delivery and receipt apparatus 220 can be executed in the OS environments and the middleware environments in the information processing capability providing apparatus 200 or not. In other words, it is examined whether operation made depending on different version of the OS and the middleware is successful or not. When the execution is possible, “operated” is entered in the operability record 73 of the processing environment information calculation result information 7 stored in the memory unit 302 of the processing environment information calculation module 300 and when it is impossible, “not operated” is entered in the operability record 73.

In step 112, the operation accuracy examination function 3012 in the processing environment information calculation unit 301 of the processing environment information calculation module 300 is executed in the information processing capability providing apparatus 200 and it is judged whether the result outputted as its execution result is correct or not. In other words, when the program for realizing the request service contents to be bid by the information processing capability delivery and receipt apparatus 220 is executed in the OS environments and the middleware environments in the information processing capability providing apparatus 200, the operation accuracy examination function 3012 judges whether the execution result of the program is correct or not. When the execution result is correct, “o” is entered in the operation accuracy record 74 of the processing environment information calculation result information 7 stored in the memory unit 302 of the processing environment information calculation module 300 and when the execution result is not correct, “x” is entered in the operation accuracy record 74.

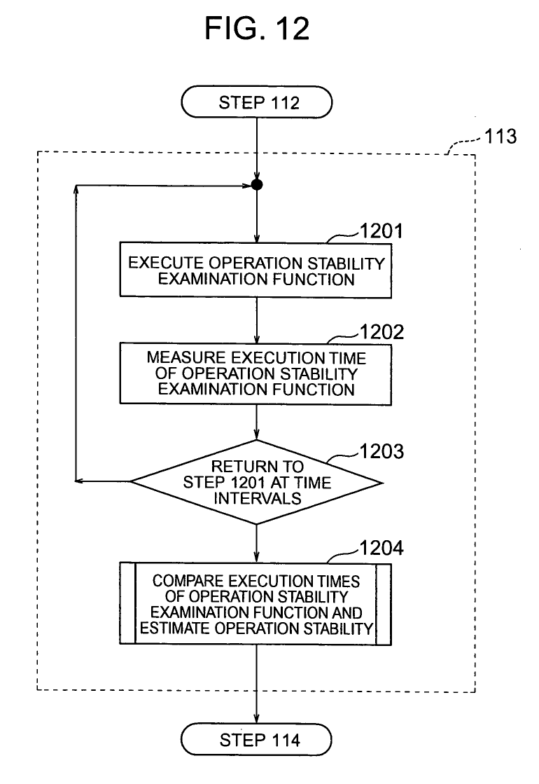

In step 113, the operation stability examination function 3013 in the processing environment information calculation unit 301 of the processing environment information calculation module 300 is executed in the information processing capability providing apparatus 200 and the degree of operation stability is judged as its execution result. This detailed processing procedure will be described with reference to FIG. 12. The degree of operation stability is entered in the operation stability record 75 of the processing environment information calculation result information 7 stored in the memory unit 302 of the processing environment information calculation module 300.

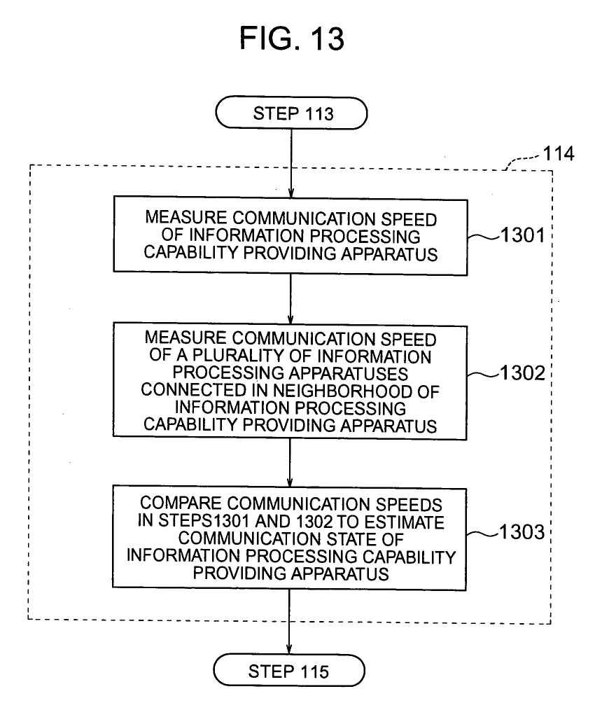

In step 114, the communication network state examination function 3014 in the processing environment information calculation unit 301 of the processing environment information calculation module 300 is executed in the information processing capability providing apparatus 200 and the communication network state is judged as its execution result. This detailed processing procedure will be described with reference to FIG. 13.

Referring now to the flowchart of FIG. 12, the processing procedure (step 113 of FIG. 11) for judging the degree of operation stability as the quality of the information processing capability of the information processing capability providing apparatus 200 is described in detail.

In step 1201, the test program which is completed in a short time (several minutes, for example) and provided in the operation stability examination function 3013 of the processing environment information calculation unit 301 is executed in the information processing capability providing apparatus 200.

In step 1202, an execution time from the start time to the end time of the test program executed in step 1201 is measured and its measured time is temporarily stored.

In step 1203, after completion of the processing in step 1202, the process is returned to step 1202 after an interval of several minutes or several tens minutes, for example. When the number of times of processing operations of step 1203 is counted and the count exceeds a predetermined number of times, the process proceeds to step 1204.

In step 1204, a plurality of processing times stored temporarily in step 1202 are compared and the degree of operation stability of the information processing capability providing apparatus is estimated as “excellent, good, pass and failure” on the basis of the degree that the processing time falls within a range of certain time.

Referring now to the flowchart of FIG. 13, the processing procedure (step 114 of FIG. 11) of judging the state of the communication network connected to the information processing capability providing apparatus 200 as the quality of the information processing capability of the information processing capability providing apparatus 200 is described in detail.

In step 1301, the communication network state examination function 3014 of the processing environment information calculation unit 301 is executed in the information processing capability providing apparatus 200 and dummy data, for example, is transmitted between the information processing capability providing apparatus 200 and the information processing capability transaction apparatus 210 to measure the communication speed between the apparatuses. The communication network state is estimated as “excellent, good, pass and failure” stepwise on the basis of the degree of the communication speed. The estimated result is entered in the communication network state record 76 of the processing environment information calculation result information 7.

In step 1302, the communication network state examination function 3014 of the processing environment information calculation unit 301 is executed in the information processing capability providing apparatus 200 and dummy data, for example, is transmitted between the information processing capability providing apparatus 200 and a plurality of information processing apparatuses different from the information processing capability apparatus 200 and connected in the neighborhood of the communication network connected to the information processing capability apparatus 200 to measure the communication speed between the plurality of information processing apparatuses and the information processing capability providing apparatus 200.

In step 1303, the communication speed measured in step 1301 is compared with the communication speed measured in step 1302 to thereby estimate the communication network state connected to the information processing capability providing apparatus 200. When there is no large difference in the communication speed, the communication network state connected to the information processing capability providing apparatus 200 is estimated as “excellent” and when there is large difference, the communication network state connected to the information processing capability providing apparatus 200 is estimated as “failure”. Further, stepwise estimation including “excellent, good, pass and failure” can be made in accordance with the magnitude of the comparison result instead of only two estimation results of “excellent and failure”. The estimation result is entered in the comparison-with-neighboring-apparatus record 77 of the processing environment information calculation result information 7.

Referring now to the flowchart of FIG. 14, the processing procedure (step 14 of FIG. 1) of preparing and displaying the product list (FIG. 15) as the information processing capability provided by the information processing capability providing apparatus 200 which is planning to make answerable bid is described in detail.

In step 1401, the information processing capability transaction apparatus 210 reads in the desirable offered price information 59 stored in the desirable offered price record 59 for the answerable bid plan information 5 stored in the memory unit 213 and also reads in the operability information 73 stored in the operability record 73, the operation accuracy information 74 stored in the operation accuracy record 74, the operation stability information 75 stored in the operation stability record 75, the communication network state information 76 stored in the communication network state record 76 and the comparison-with-neighboring-apparatus information 77 stored in the comparison-with-neighboring-apparatus record 77 for the processing environment information calculation result information 7. The desirable offered price information 59 and the operability information 73, the operation accuracy information 74, the operation stability information 75, the communication network state information 76 and the comparison-with-neighboring-apparatus information 77 which are the processing environment information are used to calculate the bid standard price and the calculated bid standard price is stored in the bid standard price record 84 for the bid standard information 8. For example, when the desirable offered price information is “2.0 yen/sec.”, the operability information “operated (1.0)”, the operation accuracy information “o (1.0)”, the operation stability information “stable (1.0)”, the communication network state information “excellent (1.5)” and the comparison-with-neighboring-apparatus “good (1.0)”, the bid standard price is 2.0×1×1××1×1.5×1=3.0, that is, “3.0 yen/sec.”.

In step 1402, the answerable bid plan information 5, the processing environment information calculation result information and the bid standard information 8 read in step 1401 are used to prepare the product list 1501 and the product list 1501 is transmitted through the communication unit 214 to the information processing capability providing apparatus 200 identified by the apparatus name 52 and the information processing capability delivery and receipt apparatus 220 identified by the apparatus name 42 to be displayed in the input/output unit 202 of the information processing capability providing apparatus 200 and the input/output unit 222 of the information processing capability delivery and receipt apparatus 220. An example of a picture displayed in the input/output unit 202 and the input/output unit 222 in step 1402 is shown in FIG. 15.

In FIG. 15, numeral 1501 denotes a screen frame or a window, 1502 a label of “PRODUCT LIST”, 1503 large items in which broadly divided item information is displayed, 1504 middle and small items in which detailed item information is displayed, 1505 data items in which the apparatus name 52, the start data, the start time, the end date, the end time, presence of the processing completion assurance, the OS kind, the middleware kind, the domain name of the communication network, the line kind, the offered service list, presence of the bid request, the bid requester name, the bid request contents, the degree of operation accuracy, the degree of operation stability, the estimation result of the communication network state, the comparison of the information processing capability providing apparatus with neighboring center and the price contents for each information processing capability providing apparatus are displayed.

According to the embodiment, since the processing environment information of the information processing capability providing apparatus can be measured by the processing environment information calculation module having the function of calculating the processing environment information of data processing, the information processing capability delivery and receipt apparatus can grasp the information processing capability of the information processing capability providing apparatus such as, for example, the operability of program, the operation accuracy (the calculated result is exact numerical value or not), the operation stability and the speed of the communication before requiring the information processing capability providing apparatus to execute data processing in execution of information processing or/and program.

### Embodiment 2

In the embodiment 2, the processing that the amount or the quality of the data processing executed by the information processing capability providing apparatus is measured by the information processing capability transaction apparatus 210 is described.

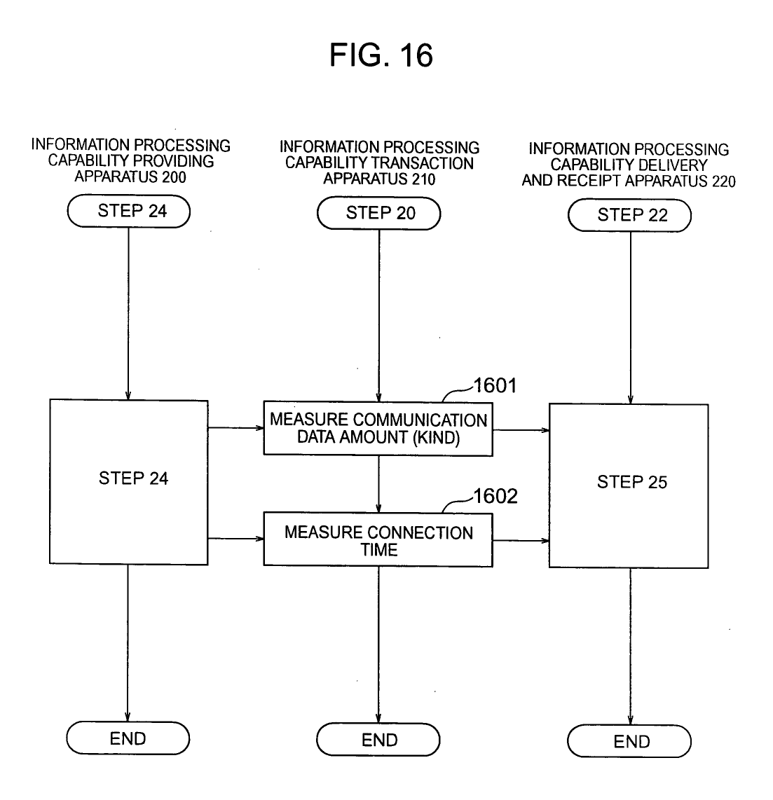

FIG. 16 is a flowchart showing processing procedure of basic operation of the information processing capability transaction apparatus of the embodiment.

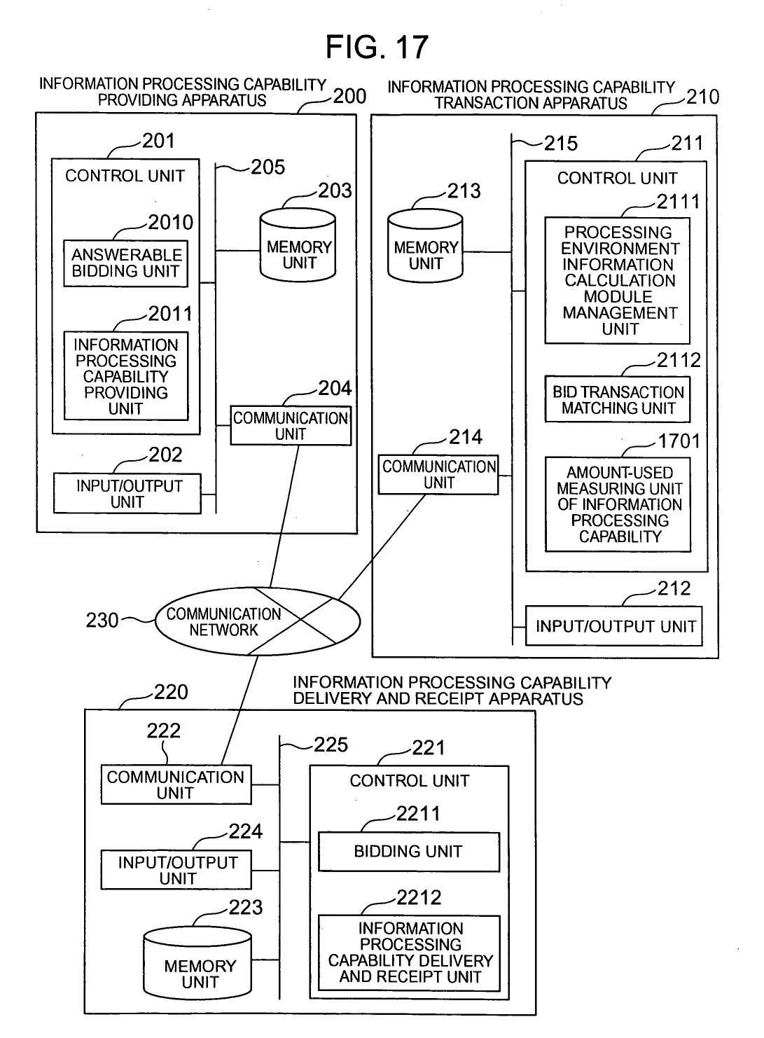

FIG. 17 is a schematic diagram illustrating the information processing capability transaction apparatus of the embodiment. The information processing capability transaction apparatus of the embodiment shown in FIG. 17 has substantially the same configuration as that of FIG. 2 used in the embodiment 1 with the exception that an amount-used measuring unit 17.01 of information processing capability is added in the information processing capability transaction apparatus 210.

Only different points of the embodiment 2 from the embodiment 1 are now described.

In the embodiment, as shown in FIG. 16, in step 24, the information processing capability providing apparatus 200 executes data processing in execution of information processing or/and program received from the information processing capability delivery and receipt apparatus and transmits its result to the information processing capability delivery and receipt apparatus in the same manner as the embodiment 1.

In the second embodiment, the processing procedures that the information processing capability transaction apparatus 210 brokers between the information processing capability providing apparatus 200 and the information processing capability delivery and receipt apparatus 220 which perform provision, delivery and receipt of data processing results in steps 24 and 25 are added. More particularly, as shown in FIG. 16, in steps 1601 and 1602, the information processing capability transaction apparatus 210 measures the quality and amount of the data processing result on the basis of the data processing result provided by the information processing capability providing apparatus 200 in step 24 and transmits its data processing result to the information processing capability delivery and receipt apparatus 220.

In step 1601, the information processing capability transaction apparatus 210 receives the data processing result from the information processing capability providing apparatus 200 and transmits its data processing result to the information processing capability delivery and receipt apparatus 220. The information processing capability transaction apparatus 210 measures an amount of communication data, for example.

In step 1602, the information processing capability transaction apparatus 210 receives the data processing result from the information processing capability providing apparatus 200 and transmits its data processing result to the information processing capability delivery and receipt apparatus 220. The information processing capability transaction apparatus 210 measures the term from the start time to the end time of providing the information processing capability, for example.

By the provision of the means for easily measuring the transaction amount (amount used) of the information processing capability, the information processing capability delivery and receipt apparatus and the information processing capability providing apparatus do not require the function and the facilities for measuring the amount and charge used. Furthermore, since the information processing capability transaction apparatus connects the information processing apparatuses for bid and answerable bid and grasps the unit price (e.g. standard price decided on the basis of time and amount used) of the information processing capability amount transacted between both apparatuses, setting of the price between the information processing apparatuses is easy when the amount of delivery and receipt of the information processing capability between the information processing capability providing apparatus and the information processing capability delivery and receipt apparatus is grasped. The information processing capability providing apparatus does not require the function and facilities for measuring the data processing result provided and further the information processing capability delivery and receipt apparatus does not require the function and facilities for measuring the data processing result received. Consequently, transaction between the information processing apparatuses having no means for measuring the data processing result can be attained.

According to the present invention, the transaction of the information processing capability using the information processing capability transaction apparatus aims at the transaction of the information processing capability of many and unspecified information processing apparatuses and the information processing capability transaction apparatus according to the present invention increases the number of information processing apparatuses which transact the information processing capability easily.

The present invention is available for transaction of the result of the data processing in execution of information processing or/and program.

The information processing capability delivery and receipt apparatus can select the information processing capability providing apparatus which executes the data processing after grasping the processing environments.

Further, the more satisfactory transaction brokering apparatus and method can be provided to the information processing capability delivery and receipt apparatus and the information processing capability providing apparatus.

It should be further understood by those skilled in the art that although the foregoing description has been made on embodiments of the invention, the invention is not limited thereto and various changes and modifications may be made without departing from the spirit of the invention and the scope of the appended claims.

1. An information processing capability transaction apparatus connected through a transmission path to an information processing capability delivery and receipt apparatus which transmits request information for requesting data processing in execution of information processing or/and program and a plurality of information processing capability providing apparatuses which execute the data processing, comprising:
reception means for receiving a plurality of answerable bid plan information containing possible conditions on which the data processing can be made by said information processing capability providing apparatuses and identifiers for identifying said information processing capability providing apparatuses from said plurality of information processing capability providing apparatuses and bid plan information containing desired conditions of the data processing from said information processing capability delivery and receipt apparatus;
memory means for storing said plurality of answerable bid plan information received in a memory unit;
retrieval means for retrieving said answerable bid plan information containing said possible conditions corresponding to said received desired conditions from said memory unit; and
transmission means for transmitting a request for operating a calculation module which calculates processing environment information indicative of processing environments of the data processing corresponding to said bid plan information to said information processing capability providing apparatus identified by said identifier contained in said retrieved answerable bid plan information;
said reception means receiving said processing environment information calculated;
said transmission means transmitting said processing environment information to said information processing capability delivery and receipt apparatus.

2. An information processing capability transaction apparatus according to claim 1, wherein
said transmission means transmits said request and said calculation module to said information processing capability providing apparatus.

3. An information processing capability transaction apparatus according to claim 1, wherein
said retrieval means retrieves said plurality of answerable bid plan information, and
said transmission means transmits said request for operating said calculation module to said plurality of information processing capability providing apparatuses and said plurality of processing environment information and said identifiers for identifying said information processing capability providing apparatuses corresponding to said processing environment information to said information processing capability delivery and receipt apparatus;
said reception means receiving said respective processing environment information from said plurality of information processing capability providing apparatuses and information for designating said information processing capability providing apparatus by which the data processing is desired to be made from said information processing capability delivery and receipt apparatus.

4. An information processing capability transaction apparatus according to claim 1, further comprising:
measurement means for measuring an amount of data processing when said information processing capability providing apparatus executes the data processing.

5. An information processing capability transaction method in an information processing capability transaction apparatus connected through a transmission path to an information processing capability delivery and receipt apparatus which transmits request information for requesting data processing in execution of information processing or/and program and a plurality of information processing capability providing apparatuses which execute the data processing, comprising:
receiving a plurality of answerable bid plan information containing possible conditions on which the data processing can be made by said information processing capability providing apparatuses and identifiers for identifying said information processing capability providing apparatuses from said plurality of information processing capability apparatuses;
storing said plurality of answerable bid plan information received in a memory unit;
receiving bid plan information containing desired conditions of the data processing from said information processing capability delivery and receipt apparatus;
retrieving said answerable bid plan information containing said possible conditions corresponding to said desired conditions from said memory unit;
transmitting a request for operating a calculation module which calculates processing environment information indicative of processing environments of the data processing corresponding to said bid plan information to said information processing capability providing apparatus identified by said identifier contained in said retrieved answerable bid plan information;
receiving said processing environment information calculated from said information processing capability providing apparatus; and
transmitting said processing environment information to said information processing capability delivery and receipt apparatus.

6. An information processing capability transaction method according to claim 5, wherein
said transmitting step of said request for operating said calculation module comprises transmitting said request and said calculation module to said information processing capability providing apparatus.

7. An information processing capability transaction method according to claim 5, wherein
said retrieving step of said answerable bid information comprises retrieving said plurality of answerable bid plan information, and
said transmitting step of said request for operating said calculation module comprises transmitting said request to said plurality of information processing capability providing apparatuses,
said receiving step of said processing environment information comprising receiving said processing environment information from each of said plurality of information processing capability providing apparatuses,
said transmitting step of said processing environment information comprising transmitting said plurality of processing environment information and said identifiers for identifying said information processing capability providing apparatuses corresponding to said processing environment information to said information processing capability delivery and receipt apparatus,
said receiving step of said processing environment information calculated comprising receiving information for designating said information processing capability providing apparatus by which the data processing is desired to be made from said information processing capability delivery and receipt apparatus.

8. An information processing capability transaction method according to claim 5, further comprising
measuring an amount of data processing when said information processing capability providing apparatus executes said data processing.
